(19) United States
(12) Patent Application Publication
(10) Pub. No.: US 2025/0368801 A1
(43) Pub. Date: Dec. 4, 2025

(54) METAL-ORGANIC THERMOSET POLYMERS

(71) Applicant: Georgia Tech Research Corporation, Atlanta, GA (US)

(72) Inventors: Lukas Graber, Atlanta, GA (US); Shreya Ghosh, Atlanta, GA (US); Gabriel J. Langston, Atlanta, GA (US); Theodore Uhrik, Atlanta, GA (US); Kyriaki Kalaitzidou, Atlanta, GA (US); Natalie Stingelin, Atlanta, GA (US); Zhiyang Jin, Atlanta, GA (US); Antonio Facchetti, Atlanta, GA (US); Jaehyun Cho, Atlanta, GA (US); Blair Kathryn Brettmann, Atlanta, GA (US); Alfonso J. Cruz, Atlanta, GA (US)

(21) Appl. No.: 19/225,325

(22) Filed: Jun. 2, 2025

Related U.S. Application Data
(60) Provisional application No. 63/654,323, filed on May 31, 2024.

(51) Int. Cl. C08K 5/057; C08G 59/18; C08J 3/20; C08J 3/24; C08K 5/092; C08L 63/00

(52) U.S. Cl. CPC C08K 5/057; C08G 59/18; C08J 3/203; C08J 3/244; C08J 3/247; C08K 5/092; C08L 63/00; C08G 2120/00; C08J 2363/00

(57) ABSTRACT

Metal-organic thermoset polymers are provided. The metal-organic thermoset polymers can be formed from a mixture including at least one epoxy resin and at least one metal alkoxide. Articles including the metal-organic thermoset polymers and processes for manufacturing the metal-organic thermoset polymers are also provided.

### CROSS-REFERENCE TO RELATED APPLICATIONS

This application claims the benefit of priority to U.S. Provisional Patent Application No. 63/654,323, filed May 31, 2024, the disclosure of which is incorporated herein by reference in its entirety.

### BACKGROUND

Metal-organic thermoset polymers can exhibit material properties that are different from conventional thermoset polymers and polymer composites. These material properties can be beneficial for certain applications, such as those with combined electrical-thermal-mechanical stress. One of the challenges in manufacturing such polymers in some instances is the different phase of metal-organic substances and pre-polymer resins; while the former can be a liquid in some instances, in others it is solid at room temperature while the latter is a viscous liquid. A typical solution is ultrasonic stirring the two components together. However, the high viscosity of the pre-polymer makes this difficult. Another typical solution is to dissolve the solid metal-organic substance. This introduces the challenge of evaporating the solvent after mixing the components, which adds cost and complexity, especially for bulk casting. Another challenge with metal-organic composites with metal particles are the particle's poor dispersion. With discrete phase separation of pre-polymer and metal-organic species, aggregation and void formation may occur, resulting in inferior mechanical, thermal, and electrical properties.

### SUMMARY

In accordance with the purposes of the disclosed materials and methods, as embodied and broadly described herein, the disclosed subject matter, in one aspect, relates to compositions, articles, and methods of making and using compositions and articles.

In one aspect, the present disclosure provides metal-organic thermoset polymers. In some aspects, the metal-organic thermoset polymer can be formed from a mixture including one or more components as described further herein. In some aspects, the mixture can include at least one epoxy resin. In some aspects, the mixture can include at least one metal alkoxide.

In another aspect, an article is provided including a metal-organic thermoset polymer as described herein.

In another aspect, processes for preparing a metal-organic thermoset polymer described herein are provided. In some aspects of, the process can include heating a first mixture comprising an epoxy resin as described herein and a second mixture comprising a metal-organic compound as described herein to a temperature above the melting point of the metal-organic compound. In some aspects, the process can further include mixing the first mixture and the second mixture to form a third mixture.

In another aspect, the process can include mixing at least one epoxy resin and at least one metal alkoxide to form a mixture. In some aspects, the process can further include heating the mixture to a temperature above the melting point of the metal alkoxide to form the metal-organic thermoset polymer.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more aspect of the disclosure are set forth in the accompanying drawings and the description below. Other features, objects, and advantages of the disclosure will be apparent from the description, the drawings, and the claims.

### DESCRIPTION OF DRAWINGS

FIG. 1 depicts the reaction of aluminum isopropoxide with epoxy resin at atmospheric pressure (resulting in bubbles) and at 280 psi (resulting in a clear sample, though with surface roughness) as described in the examples.

FIG. 2 depicts and provides data regarding the thermal degradation of the CPHP and FPLP Epoxy-ALP samples as described in the examples.

FIG. 3 provides a representative schematic for a setup for implementing a process as described herein.

FIG. 4 depicts “dogbone” samples for tensile strength tests and disk samples for thermal conductivity tests as described in the examples.

FIG. 5 depicts the Instron 5967 for testing the tensile strength as described in the examples.

FIG. 6 provides data regarding the tensile strength for alumina samples as described in the examples.

FIG. 7 provides data regarding the tensile strength for samples with aluminum isopropoxide as described in the examples.

FIG. 8 depicts the Linseris Chip-DSC 10 for measuring the heat capacity of both samples as described in the examples.

FIG. 9 provides data regarding the temperature profile with input heat flow for the alumina samples as described in the examples.

FIG. 10 provides data regarding the temperature profile with input heat flow for the samples with aluminum isopropoxide as described in the examples.

FIG. 11 depicts the thermal conductivity measurement setup as described in the examples.

FIG. 12 depicts cured disk samples (top row: samples with aluminum isopropoxide; bottom row: alumina samples) as described in the examples.

FIG. 13 provides data regarding an isotherm DSC of material as described herein containing 20% aluminum isopropoxide to determine if an exothermic peak is observed.

FIGS. 14A and 14B provide data regarding cyclic DSC to determine if the resulting product as described herein forms a crosslinked structure.

FIG. 15 provides data regarding an isotherm DSC of materials as described herein containing aluminum isopropoxide as a fine powder at varying concentrations.

FIG. 16 provides data regarding a cyclic DSC of materials as described herein containing aluminum isopropoxide as a fine powder at varying concentration.

FIG. 17 depicts materials as described herein having varying concentrations of aluminum isopropoxide.

### DETAILED DESCRIPTION

The following disclosure description is provided as an enabling teaching of the disclosure in its best, currently known aspects. Many modifications and other aspects disclosed herein will come to mind to one skilled in the art to which the disclosed compositions and methods pertain, benefiting from the teachings presented in the descriptions herein and the associated drawings. Therefore, it is understood that the disclosures are not limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or any other order that is logically possible. Unless otherwise expressly stated, it is in no way intended that any method or aspect set forth herein be construed as requiring that its steps be performed in a specific order. Accordingly, where a method claim does not explicitly state in the claims or descriptions that the steps are to be limited to a particular order, it is in no way intended that an order be inferred in any respect. This holds for any possible non-express basis for interpretation, including logic concerning arrangement of steps or operational flow, meaning derived from grammatical organization or punctuation, or the number or type of aspects described in the specification.

All publications mentioned herein are incorporated by reference to disclose and describe the methods or materials in connection with which the publications are cited. The publications discussed herein are provided solely for their disclosure before the filing date of the present application. Further, the dates of publication provided herein can be different from the actual publication dates, which can require independent confirmation.

It is also to be understood that the terminology herein describes particular aspects only and is not intended to be limiting. Unless defined otherwise, all technical and scientific terms herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Before describing the various aspects of the present disclosure, the following definitions are provided and should be used unless otherwise indicated. Additional terms may be defined elsewhere in the present disclosure.

### Definitions

As used herein, “comprising” is interpreted as specifying the presence of the stated features, integers, steps, or components but does not preclude the presence or addition of one or more features, integers, steps, components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, “consisting essentially of” is intended to include examples encompassed by the term “consisting of.”

As used in the specification and the appended claims, the singular forms “a,” “an,” and “the” include plural referents unless the context dictates otherwise.

Ratios, concentrations, amounts, and other numerical data can be expressed herein in a range format. Further, the endpoints of each of the ranges are significant both in relation to the other endpoint and independently of the other endpoint. There are many values disclosed herein, and each value is also disclosed as “about” that particular value in addition to the value itself. For example, if the value “10” is disclosed, then “about 10” is also disclosed. Ranges can be expressed herein as from “about” one particular value and to “about” another particular value. Similarly, when values are expressed as approximations, using the antecedent “about,” the particular value forms a further aspect. For example, if the value “about 10” is disclosed, then “10” is also disclosed.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x,’ ‘about y,’ and ‘about z’ as well as the ranges of ‘less than x,’ ‘less than y.’ and ‘less than z.’ Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y’,” where ‘x’ and ‘y’ are numerical values, includes “about ‘x’ to about ‘y’.”

Such a range format is used for convenience and brevity and thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, amounts, sizes, formulations, parameters, and other quantities and characteristics are not and need not be exact but may be approximate, larger or smaller, as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In such cases, as used herein, “about” and “at or about” mean the nominal value indicated ±10% variation unless otherwise indicated or inferred. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, “optional” or “optionally” means that the subsequently described event or circumstance can or cannot occur. The description includes instances where said event or circumstance occurs and those where it does not.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Although the operations of exemplary aspects of the disclosed method may be described in a particular sequential order for convenient presentation, it should be understood that disclosed aspects can encompass an order of operations other than the particular sequential order disclosed. For example, operations described sequentially may, in some cases, be rearranged or performed concurrently. Further, descriptions and disclosures provided in association with one particular aspect are not limited to that aspect and may be applied to any aspect disclosed.

The terms “coupled” and “associated” generally mean electrically, electromagnetically, and/or physically (e.g., mechanically or chemically) coupled or linked and do not exclude the presence of intermediate elements between the coupled or associated items.

It will be understood that when an element is referred to as being “connected” or “coupled” to another element, it can be directly connected or coupled to the other element, or intervening elements can be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

It will be understood that although the terms “first,” “second,” etc., can be used herein to describe various elements, components, regions, layers and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example aspects.

Spatially relative terms, such as, “beneath,” “below,” “lower,” “above,” “upper,” “upward,” “downward,” “top,” “bottom,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein are interpreted accordingly.

Terms such as “proximal,” “distal,” “radially outward,” “radially inward,” “outer,” “inner,” and “side” describe the orientation and/or location of portions of the components or elements within a consistent but arbitrary frame of reference which is made clear by reference to the text and the associated drawings describing the components or elements under discussion. Such terminology can include the words specifically mentioned above, derivatives thereof, and words of similar import.

Similarly, the terms “first,” “second,” and other such numerical terms referring to structures neither imply a sequence nor order unless clearly indicated by the context.

As used herein, the term “substantially” means that the subsequently described event or circumstance completely occurs or that the subsequently described event or circumstance generally, typically, or approximately occurs.

Still further, the term “substantially” can, in some aspects, refer to at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

Compounds are described using standard nomenclature. Unless defined otherwise, all technical and scientific terms used herein have the same meaning as is commonly understood by one of skill in the art to which this disclosure belongs.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers, such as Sigma-Aldrich (formally MilliporeSigma, Burlington, MA) or Thermo Fisher Scientific Inc. (Waltham, MA), or are prepared by methods known to those skilled in the art following procedures set forth in references such as Fieser and Fieser's Reagents for Organic Synthesis (John Wiley and Sons, 2007); Organic Reactions (John Wiley and Sons, 2004); March's Advanced Organic Chemistry, (John Wiley and Sons, 8^{th} Edition); and Larock's Comprehensive Organic Transformations (John Wiley and Sons, 3^{rd} edition, 2017).

The references cited herein are hereby incorporated by reference to disclose and describe the methods or materials in connection with which the publications are cited or provide background for the present disclosure. Any incorporation by reference of documents herein is limited such that no subject matter is incorporated by reference contrary to the explicit disclosure herein. In the event of inconsistent usages between this document and those documents so incorporated by reference herein, the use in the incorporated references should be considered supplementary to that of this document; for irreconcilable inconsistencies, the usage in this document controls.

### Metal-Organic Thermoset Polymers

In one aspect, the present disclosure provides metal-organic thermoset polymers. In some aspects, the metal-organic thermoset polymer can be formed from a mixture including one or more components as described further herein.

In some aspects, the mixture can include at least one epoxy resin. As used herein, an “epoxy resin” refers to a reactive prepolymer and/or polymer containing a plurality of epoxide functional groups. The mixture can include one epoxy resin or a combination of one or more epoxy resins. In some aspects, the at least one epoxy resin can include an aliphatic epoxy resin, a bisphenol epoxy resin, a novolac epoxy resin, a glycidylamine epoxy resin, a halogenated epoxy resin, or combinations thereof.

In some aspects, the mixture can include an aliphatic epoxy resin. In some aspects, the aliphatic epoxy resin is obtained by epoxidation of double bonds. In some aspects, the aliphatic epoxy resin includes a cycloaliphatic epoxide. Representative examples include, but are not limited to, 3,4-epoxycyclohexylmethyl 3,4-epoxycyclohexanecarboxylate (ECC) and bis[3,4-epoxycyclohexylmethyl] adipate (BECHMA). In some aspects, the aliphatic epoxy resin includes an epoxidized vegetable oil, such as epoxidized soybean oil or epoxidized castor oil. In some aspects the aliphatic epoxy resin can include a glycidyl ether or glycidyl ester. Such aliphatic epoxy resins may be obtained by reaction of epichlorohydrin with aliphatic alcohols, aliphatic polyols, or aliphatic carboxylic acids. Representative examples include, but are not limited to, 1,4-butane diol diglycidyl ether, neopentyl glycol diglycidyl ether, butyl glycidyl ether, 2-ethylhexyl glycidyl ether, phenyl glycidyl ether, tert-butyl glycidyl ether, o-cresyl glycidyl ether, allyl glycidyl ether, 1,6-bis(2,3-epoxypropoxy)naphthalene, n-butyl glycidyl ether, C12-C13 alcohol glycidyl ether, C12-C14 alcohol glycidyl ether, castor oil glycidyl ether, 1,4-cyclohexanedimethanol diglycidyl ether, dibromoneopentyl glycol diglycidyl ether, diethylene glycol diglycidyl ether, diglycidyl ether, diglycidyl resorcinol ether, glycerol triglycidyl ether, 1,6-hexanediol diglycidyl ether, poly(propylene glycol) diglycidyl ether, trimethylolethane triglycidyl ether, and trimethylolpropane triglycidyl ether.

In some aspects, the mixture can include a bisphenol epoxy resin. Bisphenol epoxy resins are obtained by reaction of epichlorohydrin with a bisphenol, such as bisphenol A, bisphenol F, bisphenol AF, or bisphenol S. Representative examples include, but are not limited to, bisphenol A diglycidyl ether (DGEBA) and bisphenol F diglycidyl ether.

In some aspects, the mixture can include a novolac epoxy resin (also referred to as phenolic resins). Novolacs (also referred to as novolaks) are low molecular weight polymers derived from phenols (such as phenol, p-cresol, m-cresol, resorcinol, or mixtures thereof) and formaldehyde. Novolac epoxy resins may be obtained from reaction of novolacs and epichlorohydrin. Representative examples include, but are not limited to, epoxyphenol novolac (EPN), epoxycresol novolac (ECN), and resorcinol novolac epoxy resins.

In some aspects, the mixture can include a glycidylamine epoxy resin. Glycidylamine epoxy resins may be obtained from the reaction of aromatic amines and epichlorohydrin. Representative examples include, but are not limited to, triglycidyl p-amino phenol (TGPAP), triglycidyl m-amino phenol, diglycidyl p-amino phenol ether, and N,N,N′,N′-tetraglycidyl-bis-(4-aminophenyl)-methane (TGMDA).

In some aspects, the mixture can include a halogenated epoxy resin. Representative examples include, but are not limited to, tetrabromobisphenol A diglycidyl ether, dibromo neopentyl glycol diglycidyl ether, or 5-heptafluoropropyl-1,3-bis[2-(2,3-epoxypropoxy)hexafluoro-2-propyl]benzene.

In some aspects, the at least one epoxy resin is present in an amount from about 70% to about 95% by weight based on a total weight of the mixture, including exemplary values of about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, or any subrange formed from the above exemplary values. In some aspects, the at least one epoxy resin is present in an amount from about 80% to about 95% by weight, more particularly about 80% by weight, based on a total weight of the mixture.

In some aspects, the mixture can include at least one metal alkoxide. In some aspects, the at least one metal alkoxide can include an aluminum alkoxide, a titanium alkoxide, an indium alkoxide, or combinations thereof.

In some aspects, the at least one metal alkoxide can include a metal ethoxide, a metal isopropoxide, a metal tert-butoxide, a metal sec-butoxide, a metal n-butoxide, a metal pentoxide, a metal phenoxide, or combinations thereof.

In some aspects, the at least one metal alkoxide can include an aluminum alkoxide. Representative examples include, but are not limited to, aluminum ethoxide, aluminum isopropoxide, aluminum tert-butoxide, aluminum sec-butoxide, aluminum pentoxide, and aluminum phenolate.

In some aspects, the at least one metal alkoxide can include a titanium alkoxide, for example, titanium isopropoxide and titanium butoxide.

In some aspects, the at least one metal alkoxide can include an indium alkoxide, for example indium isopropoxide.

In some particular aspects, the at least one metal alkoxide can include aluminum isopropoxide.

In some aspects, the at least one metal alkoxide is present in an amount from about 5% to about 30% by weight based on a total weight of the mixture, including exemplary values of about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, or any subrange formed from the above exemplary values. In some aspects, the at least one metal alkoxide is present in an amount from about 5% to about 20% by weight, more particularly about 20% by weight, based on a total weight of the mixture.

In some aspects, the epoxy resin and metal alkoxide are at least partially crosslinked. The metal-organic thermoset polymer can be crosslinked via reaction between the epoxy functional groups of the epoxy resin and the metal alkoxide as described herein. In some aspects, the polymer is formed in the absence of a hardener and/or catalyst. In such aspects, the polymer is cured solely via reaction (e.g., crosslinking) between the epoxy resin and metal alkoxide.

In other aspects, the mixture can further include a hardener, an inhibitor, or a catalyst. Inclusion to further facilitate curing of the mixture or to refine the rate at which said curing occurs. In some aspects, the mixture further includes a hardener, such as an amine, anhydride, phenol, or thiol. In some aspects, the mixture further includes an inhibitor. Representative examples of inhibitors include, but are not limited to, citric acid. In some aspects, the inhibitor is present in an amount from about 0% to about 10% by volume based on the total volume of the mixture. In some aspects, the mixture further includes a catalyst. Representative examples of catalysts include, but are not limited to, dianhydrides. In some aspects, the catalyst is present in an amount from about 0% to about 10% by volume based on the total volume of the mixture. In one non-limiting example, a catalyst described herein may induce homopolymerization of the mixtures described herein.

### Articles

In another aspect, an article is provided including a metal-organic thermoset polymer as described herein.

The article can be any item for which it is suitable to be manufactured from or composed of a metal-organic thermoset polymer described herein. In some aspects, the article can include an optical material, for example a photonic crystal. In some aspects, the article can include a radiation shielding material. In some aspects, the article can include a structural material. In some aspects, the article can include an insulation material, such as bushings for electrical transmission or battery packaging. In some aspects, the article can include an adhesive, a coating, or a sealant. In some aspects, the article can include an electronic material, for example a bipolar plate for a fuel cell. In some aspects, the article can include a biomaterial. In some aspects, the article can include an automotive material. In some aspects, the article can include a textile.

In some aspects of the articles described herein, the metal-organic thermoset polymer can be formed from a mixture including one or more components as described further herein.

In some aspects of the articles described herein, the mixture can include at least one epoxy resin. The mixture can include one epoxy resin or a combination of one or more epoxy resins. In some aspects of the articles described herein, the at least one epoxy resin can include an aliphatic epoxy resin, a bisphenol epoxy resin, a novolac epoxy resin, a glycidylamine epoxy resin, a halogenated epoxy resin, or combinations thereof.

In some aspects of the articles described herein, the mixture can include an aliphatic epoxy resin. In some aspects of the articles described herein, the aliphatic epoxy resin is obtained by epoxidation of double bonds. In some aspects of the articles described herein, the aliphatic epoxy resin includes a cycloaliphatic epoxide. Representative examples include, but are not limited to, 3,4-epoxycyclohexylmethyl 3,4-epoxycyclohexanecarboxylate (ECC) and bis[3,4-epoxycyclohexylmethyl] adipate (BECHMA). In some aspects of the articles described herein, the aliphatic epoxy resin includes an epoxidized vegetable oil, such as epoxidized soybean oil or epoxidized castor oil. In some aspects of the articles described herein, the aliphatic epoxy resin can include a glycidyl ether or glycidyl ester. Such aliphatic epoxy resins may be obtained by reaction of epichlorohydrin with aliphatic alcohols, aliphatic polyols, or aliphatic carboxylic acids. Representative examples include, but are not limited to, 1,4-butane diol diglycidyl ether, neopentyl glycol diglycidyl ether, butyl glycidyl ether, 2-ethylhexyl glycidyl ether, phenyl glycidyl ether, tert-butyl glycidyl ether, o-cresyl glycidyl ether, allyl glycidyl ether, 1,6-bis(2,3-epoxypropoxy)naphthalene, n-butyl glycidyl ether, C12-C13 alcohol glycidyl ether, C12-C14 alcohol glycidyl ether, castor oil glycidyl ether, 1,4-cyclohexanedimethanol diglycidyl ether, dibromoneopentyl glycol diglycidyl ether, diethylene glycol diglycidyl ether, diglycidyl ether, diglycidyl resorcinol ether, glycerol triglycidyl ether, 1,6-hexanediol diglycidyl ether, poly(propylene glycol) diglycidyl ether, trimethylolethane triglycidyl ether, and trimethylolpropane triglycidyl ether.

In some aspects of the articles described herein, the mixture can include a bisphenol epoxy resin. Bisphenol epoxy resins are obtained by reaction of epichlorohydrin with a bisphenol, such as bisphenol A, bisphenol F, bisphenol AF, or bisphenol S. Representative examples include, but are not limited to, bisphenol A diglycidyl ether (DGEBA) and bisphenol F diglycidyl ether.

In some aspects of the articles described herein, the mixture can include a novolac epoxy resin (also referred to as phenolic resins). Novolacs (also referred to as novolaks) are low molecular weight polymers derived from phenols (such as phenol, p-cresol, m-cresol, or mixtures thereof) and formaldehyde. Novolac epoxy resins may be obtained from reaction of novolacs and epichlorohydrin. Representative examples include, but are not limited to, epoxyphenol novolac (EPN) and epoxycresol novolac (ECN).

In some aspects of the articles described herein, the mixture can include a glycidylamine epoxy resin. Glycidylamine epoxy resins may be obtained from the reaction of aromatic amines and epichlorohydrin. Representative examples include, but are not limited to, triglycidyl p-amino phenol and N,N,N′,N′-tetraglycidyl-bis-(4-aminophenyl)-methane (TGMDA).

In some aspects of the articles described herein, the mixture can include a halogenated epoxy resin. Representative examples include, but are not limited to, tetrabromobisphenol A diglycidyl ether, dibromo neopentyl glycol diglycidyl ether, or 5-heptafluoropropyl-1,3-bis[2-(2,3-epoxypropoxy) hexafluoro-2-propyl]benzene.

In some aspects of the articles described herein, the at least one epoxy resin is present in an amount from about 70% to about 95% by weight based on a total weight of the mixture, including exemplary values of about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, or any subrange formed from the above exemplary values. In some aspects of the articles described herein, the at least one epoxy resin is present in an amount from about 80% to about 95% by weight, more particularly about 80% by weight, based on a total weight of the mixture.

In some aspects of the articles described herein, the mixture can include at least one metal alkoxide. In some aspects of the articles described herein, the at least one metal alkoxide can include an aluminum alkoxide, a titanium alkoxide, an indium alkoxide, or combinations thereof.

In some aspects of the articles described herein, the at least one metal alkoxide can include a metal ethoxide, a metal isopropoxide, a metal tert-butoxide, a metal sec-butoxide, a metal n-butoxide, a metal pentoxide, a metal phenoxide, or combinations thereof.

In some aspects of the articles described herein, the at least one metal alkoxide can include an aluminum alkoxide. Representative examples include, but are not limited to, aluminum ethoxide, aluminum isopropoxide, aluminum tert-butoxide, aluminum sec-butoxide, aluminum pentoxide, and aluminum phenolate.

In some aspects of the articles described herein, the at least one metal alkoxide can include a titanium alkoxide, for example, titanium isopropoxide and titanium butoxide.

In some aspects of the articles described herein, the at least one metal alkoxide can include an indium alkoxide, for example indium isopropoxide.

In some particular aspects of the articles described herein, the at least one metal alkoxide can include aluminum isopropoxide.

In some aspects of the articles described herein, the at least one metal alkoxide is present in an amount from about 5% to about 30% by weight based on a total weight of the mixture, including exemplary values of about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, or any subrange formed from the above exemplary values. In some aspects of the articles described herein, the at least one metal alkoxide is present in an amount from about 5% to about 20% by weight, more particularly about 20% by weight, based on a total weight of the mixture.

In some aspects of the articles described herein, the epoxy resin and metal alkoxide are at least partially crosslinked. The metal-organic thermoset polymer can be crosslinked via reaction between the epoxy functional groups of the epoxy resin and the metal alkoxide as described herein. In some aspects of the articles described herein, the polymer is formed in the absence of a hardener and/or catalyst. In such aspects, the polymer is cured solely via reaction (e.g., crosslinking) between the epoxy resin and metal alkoxide.

In other aspects of the articles described herein, the mixture can further include a hardener, an inhibitor, or a catalyst. Inclusion to further facilitate curing of the mixture or to refine the rate at which said curing occurs. In some aspects of the articles described herein, the mixture further can include a hardener, such as an amine, anhydride, phenol, or thiol. In some aspects of the articles described herein, the mixture further can include an inhibitor. Representative examples of inhibitors include, but are not limited to, citric acid. In some aspects of the articles described herein, the inhibitor is present in an amount from about 0% to about 10% by volume based on the total volume of the mixture. In some aspects of the articles described herein, the mixture further can include a catalyst. Representative examples of catalysts include, but are not limited to, dianhydrides. In some aspects of the articles described herein, the catalyst is present in an amount from about 0% to about 10% by volume based on the total volume of the mixture. In one non-limiting example, a catalyst described herein may induce homopolymerization of the mixtures described herein.

### Processes for Manufacture

In another aspect, processes for preparing a metal-organic thermoset polymer described herein are provided. In some aspects of, the process can include heating a first mixture comprising an epoxy resin as described herein and a second mixture comprising a metal-organic compound as described herein to a temperature above the melting point of the metal-organic compound. In some aspects, the process can further include mixing the first mixture and the second mixture to form a third mixture. In some aspects, the process can further include cooling the third mixture after mixing.

In some aspects of the processes described herein, the first and/or third mixture can include one epoxy resin or a combination of one or more epoxy resins. In some aspects of the processes described herein, the at least one epoxy resin can include an aliphatic epoxy resin, a bisphenol epoxy resin, a novolac epoxy resin, a glycidylamine epoxy resin, a halogenated epoxy resin, or combinations thereof.

In some aspects of the processes described herein, the first and/or third mixture can include an aliphatic epoxy resin. In some aspects of the processes described herein, the aliphatic epoxy resin is obtained by epoxidation of double bonds. In some aspects of the processes described herein, the aliphatic epoxy resin includes a cycloaliphatic epoxide. Representative examples include, but are not limited to, 3,4-epoxycyclohexylmethyl 3,4-epoxycyclohexanecarboxylate (ECC) and bis[3,4-epoxycyclohexylmethyl] adipate (BECHMA). In some aspects, the aliphatic epoxy resin includes an epoxidized vegetable oil, such as epoxidized soybean oil or epoxidized castor oil. In some aspects of the processes described herein, the aliphatic epoxy resin can include a glycidyl ether or glycidyl ester. Such aliphatic epoxy resins may be obtained by reaction of epichlorohydrin with aliphatic alcohols, aliphatic polyols, or aliphatic carboxylic acids. Representative examples include, but are not limited to, 1,4-butane diol diglycidyl ether, neopentyl glycol diglycidyl ether, butyl glycidyl ether, 2-ethylhexyl glycidyl ether, phenyl glycidyl ether, tert-butyl glycidyl ether, o-cresyl glycidyl ether, allyl glycidyl ether, 1,6-bis(2,3-epoxypropoxy)naphthalene, n-butyl glycidyl ether, C12-C13 alcohol glycidyl ether, C12-C14 alcohol glycidyl ether, castor oil glycidyl ether, 1,4-cyclohexanedimethanol diglycidyl ether, dibromoneopentyl glycol diglycidyl ether, diethylene glycol diglycidyl ether, diglycidyl ether, diglycidyl resorcinol ether, glycerol triglycidyl ether, 1,6-hexanediol diglycidyl ether, poly(propylene glycol) diglycidyl ether, trimethylolethane triglycidyl ether, and trimethylolpropane triglycidyl ether.

In some aspects of the processes described herein, the first and/or third mixture can include a bisphenol epoxy resin. Bisphenol epoxy resins are obtained by reaction of epichlorohydrin with a bisphenol, such as bisphenol A, bisphenol F, bisphenol AF, or bisphenol S. Representative examples include, but are not limited to, bisphenol A diglycidyl ether (DGEBA) and bisphenol F diglycidyl ether.

In some aspects of the processes described herein, the first and/or third mixture can include a novolac epoxy resin (also referred to as phenolic resins). Novolacs (also referred to as novolaks) are low molecular weight polymers derived from phenols (such as phenol, p-cresol, m-cresol, or mixtures thereof) and formaldehyde. Novolac epoxy resins may be obtained from reaction of novolacs and epichlorohydrin. Representative examples include, but are not limited to, epoxyphenol novolac (EPN) and epoxycresol novolac (ECN).

In some aspects of the processes described herein, the first and/or third mixture can include a glycidylamine epoxy resin. Glycidylamine epoxy resins may be obtained from the reaction of aromatic amines and epichlorohydrin. Representative examples include, but are not limited to, triglycidyl p-amino phenol and N,N,N′,N′-tetraglycidyl-bis-(4-aminophenyl)-methane (TGMDA).

In some aspects of the processes described herein, the first and/or third mixture can include a halogenated epoxy resin. Representative examples include, but are not limited to, tetrabromobisphenol A diglycidyl ether, dibromo neopentyl glycol diglycidyl ether, or 5-heptafluoropropyl-1,3-bis[2-(2,3-epoxypropoxy) hexafluoro-2-propyl]benzene.

In some aspects of the processes described herein, the at least one epoxy resin is present in an amount from about 70% to about 95% by weight based on a total weight of the third mixture, including exemplary values of about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, or any subrange formed from the above exemplary values. In some aspects of the processes described herein, the at least one epoxy resin is present in an amount from about 80% to about 95% by weight, more particularly about 80% by weight, based on a total weight of the third mixture.

In some aspects of the processes described herein, the at least one metal alkoxide can include an aluminum alkoxide, a titanium alkoxide, an indium alkoxide, or combinations thereof.

In some aspects of the processes described herein, the at least one metal alkoxide can include a metal ethoxide, a metal isopropoxide, a metal tert-butoxide, a metal sec-butoxide, a metal n-butoxide, a metal pentoxide, a metal phenoxide, or combinations thereof.

In some aspects of the processes described herein, the at least one metal alkoxide can include an aluminum alkoxide. Representative examples include, but are not limited to, aluminum ethoxide, aluminum isopropoxide, aluminum tert-butoxide, aluminum sec-butoxide, aluminum pentoxide, and aluminum phenolate.

In some aspects of the processes described herein, the at least one metal alkoxide can include a titanium alkoxide, for example, titanium isopropoxide and titanium butoxide.

In some aspects of the processes described herein, the at least one metal alkoxide can include an indium alkoxide, for example indium isopropoxide.

In some particular aspects of the processes described herein, the at least one metal alkoxide can include aluminum isopropoxide.

In some aspects of the processes described herein, the at least one metal alkoxide is present in an amount from about 5% to about 30% by weight based on a total weight of the third mixture, including exemplary values of about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, or any subrange formed from the above exemplary values. In some aspects of the processes described herein, the at least one metal alkoxide is present in an amount from about 5% to about 20% by weight, more particularly about 20% by weight, based on a total weight of the third mixture.

In some aspects of the processes described herein, the process further can include adding a hardener described herein to the third mixture to form the metal-organic thermoset polymer.

In some aspects of the processes described herein, the process further can include adding an inhibitor described herein to the third mixture to form the metal-organic thermoset polymer.

In some aspects of the processes described herein, the process further can include adding a catalyst described herein to the third mixture to form the metal-organic thermoset polymer.

In another aspect, a process is provided for preparing a metal-organic thermoset polymer including mixing at least one epoxy resin and at least one metal alkoxide to form a mixture and heating the mixture to a temperature above the melting point of the metal alkoxide to form the metal-organic thermoset polymer.

In some aspects, heating the mixture occurs in a pressurized mold. In some aspects, the pressurized mold is at a pressure from about 100 psi to about 400 psi, including exemplary values of about 100 psi, about 110 psi, about 120 psi, about 130 psi, about 140 psi, about 150 psi, about 160 psi, about 170 psi, about 180 psi, about 190 psi, about 200 psi, about 210 psi, about 220 psi, about 230 psi, about 240 psi, about 250 psi, about 260 psi, about 270 psi, about 280 psi, about 290 psi, about 300 psi, about 310 psi, about 320 psi, about 330 psi, about 340 psi, about 350 psi, about 360 psi, about 370 psi, about 380 psi, about 390 psi, about 400 psi, or any subrange formed from the above exemplary values. In some particular aspects, the pressurized mold is at a pressure of about 300 psi.

In some aspects, heating the mixture occurs for a time period from about 5 minutes to about 120 minutes, including exemplary values of about 5 minutes, about 10 minutes, about 15 minutes, about 30 minutes, about 45 minutes, about 60 minutes, about 75 minutes, about 90 minutes, about 105 minutes, about 120 minutes, or any subrange formed from the above exemplary values.

In some aspects, heating the mixture can occur via a hot isostatic pressing (HIP) process. HIP is a manufacturing process that applies both high temperature and isostatic pressure to a material placed inside a high-pressure containment vessel. In some such aspects, the HIP process may be performed under an inert atmosphere or, alternatively, in the absence of any atmosphere.

In some aspects of the processes described herein, the mixture can include one epoxy resin or a combination of one or more epoxy resins. In some aspects of the processes described herein, the at least one epoxy resin can include an aliphatic epoxy resin, a bisphenol epoxy resin, a novolac epoxy resin, a glycidylamine epoxy resin, a halogenated epoxy resin, or combinations thereof.

In some aspects of the processes described herein, the mixture can include an aliphatic epoxy resin. In some aspects of the processes described herein, the aliphatic epoxy resin is obtained by epoxidation of double bonds. In some aspects of the processes described herein, the aliphatic epoxy resin includes a cycloaliphatic epoxide. Representative examples include, but are not limited to, 3,4-epoxycyclohexylmethyl 3,4-epoxycyclohexanecarboxylate (ECC) and bis[3,4-epoxycyclohexylmethyl] adipate (BECHMA). In some aspects, the aliphatic epoxy resin includes an epoxidized vegetable oil, such as epoxidized soybean oil or epoxidized castor oil. In some aspects of the processes described herein, the aliphatic epoxy resin can include a glycidyl ether or glycidyl ester. Such aliphatic epoxy resins may be obtained by reaction of epichlorohydrin with aliphatic alcohols, aliphatic polyols, or aliphatic carboxylic acids. Representative examples include, but are not limited to, 1,4-butane diol diglycidyl ether, neopentyl glycol diglycidyl ether, butyl glycidyl ether, 2-ethylhexyl glycidyl ether, phenyl glycidyl ether, tert-butyl glycidyl ether, o-cresyl glycidyl ether, allyl glycidyl ether, 1,6-bis(2,3-epoxypropoxy)naphthalene, n-butyl glycidyl ether, C12-C13 alcohol glycidyl ether, C12-C14 alcohol glycidyl ether, castor oil glycidyl ether, 1,4-cyclohexanedimethanol diglycidyl ether, dibromoneopentyl glycol diglycidyl ether, diethylene glycol diglycidyl ether, diglycidyl ether, diglycidyl resorcinol ether, glycerol triglycidyl ether, 1,6-hexanediol diglycidyl ether, poly(propylene glycol) diglycidyl ether, trimethylolethane triglycidyl ether, and trimethylolpropane triglycidyl ether.

In some aspects of the processes described herein, the mixture can include a bisphenol epoxy resin. Bisphenol epoxy resins are obtained by reaction of epichlorohydrin with a bisphenol, such as bisphenol A, bisphenol F, bisphenol AF, or bisphenol S. Representative examples include, but are not limited to, bisphenol A diglycidyl ether (DGEBA) and bisphenol F diglycidyl ether.

In some aspects of the processes described herein, the mixture can include a novolac epoxy resin (also referred to as phenolic resins). Novolacs (also referred to as novolaks) are low molecular weight polymers derived from phenols (such as phenol, p-cresol, m-cresol, or mixtures thereof) and formaldehyde. Novolac epoxy resins may be obtained from reaction of novolacs and epichlorohydrin. Representative examples include, but are not limited to, epoxyphenol novolac (EPN) and epoxycresol novolac (ECN).

In some aspects of the processes described herein, the mixture can include a glycidylamine epoxy resin. Glycidylamine epoxy resins may be obtained from the reaction of aromatic amines and epichlorohydrin. Representative examples include, but are not limited to, triglycidyl p-amino phenol and N,N,N′,N′-tetraglycidyl-bis-(4-aminophenyl)-methane (TGMDA).

In some aspects of the processes described herein, the mixture can include a halogenated epoxy resin. Representative examples include, but are not limited to, tetrabromobisphenol A diglycidyl ether, dibromo neopentyl glycol diglycidyl ether, or 5-heptafluoropropyl-1,3-bis[2-(2,3-epoxypropoxy) hexafluoro-2-propyl]benzene.

In some aspects of the processes described herein, the at least one epoxy resin is present in an amount from about 70% to about 95% by weight based on a total weight of the mixture, including exemplary values of about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, or any subrange formed from the above exemplary values. In some aspects of the processes described herein, the at least one epoxy resin is present in an amount from about 80% to about 95% by weight, more particularly about 80% by weight, based on a total weight of the mixture.

In some aspects of the processes described herein, the at least one metal alkoxide can include an aluminum alkoxide, a titanium alkoxide, an indium alkoxide, or combinations thereof.

In some aspects of the processes described herein, the at least one metal alkoxide can include a metal ethoxide, a metal isopropoxide, a metal tert-butoxide, a metal sec-butoxide, a metal n-butoxide, a metal pentoxide, a metal phenoxide, or combinations thereof.

In some aspects of the processes described herein, the at least one metal alkoxide can include an aluminum alkoxide. Representative examples include, but are not limited to, aluminum ethoxide, aluminum isopropoxide, aluminum tert-butoxide, aluminum sec-butoxide, aluminum pentoxide, and aluminum phenolate.

In some aspects of the processes described herein, the at least one metal alkoxide can include a titanium alkoxide, for example, titanium isopropoxide and titanium butoxide.

In some aspects of the processes described herein, the at least one metal alkoxide can include an indium alkoxide, for example indium isopropoxide.

In some particular aspects of the processes described herein, the at least one metal alkoxide can include aluminum isopropoxide.

In some aspects of the processes described herein, the at least one metal alkoxide is present in an amount from about 5% to about 30% by weight based on a total weight of the mixture, including exemplary values of about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, or any subrange formed from the above exemplary values. In some aspects of the processes described herein, the at least one metal alkoxide is present in an amount from about 5% to about 20% by weight, more particularly about 20% by weight, based on a total weight of the mixture.

In some aspects, a process described herein can be performed under the exclusion of air or in an inert atmosphere (for example, nitrogen or argon).

In some aspects, a process described herein is substantially free of solvent.

In another aspect, a metal-organic thermoset polymer is provided prepared according to any of the processes described herein.

### Additional Aspects

In view of the described compounds, compositions, and methods, hereinbelow are described certain more particular aspects of the disclosure. These particularly recited aspects should not, however, be interpreted to have any limiting effect on any different claims containing different or more general teachings described herein, or that the “particular” aspects are somehow limited in some way other than the inherent meanings of the language and formulae literally used therein.

Aspect 1. A metal-organic thermoset polymer formed from a mixture comprising:
At least one epoxy resin; and
At least one metal alkoxide.

Aspect 2. The metal-organic thermoset polymer of aspect 1, wherein the at least one metal alkoxide comprises an aluminum alkoxide, a titanium alkoxide, an indium alkoxide, or combinations thereof.

Aspect 3. The metal-organic thermoset polymer of any one of aspects 1 or 2, wherein the at least one metal alkoxide comprises a metal isopropoxide, a metal tert-butoxide, a metal sec-butoxide, a metal pentoxide, or combinations thereof.

Aspect 4. The metal organic thermoset polymer of any one of aspects 1-3, wherein the at least one metal alkoxide comprises aluminum isopropoxide.

Aspect 5. The metal-organic thermoset polymer of any one of aspects 1-4, wherein the at least one metal alkoxide is present in an amount from about 5% to about 30% by weight based on a total weight of the mixture.

Aspect 6. The metal-organic thermoset polymer of any one of aspects 1-5, wherein the at least one epoxy resin comprises an aliphatic epoxy resin, a bisphenol epoxy resin, a novolac epoxy resin, a glycidylamine epoxy resin, a halogenated epoxy resin, or combinations thereof.

Aspect 7. The metal-organic thermoset polymer of any one of aspects 1-6, wherein the at least one epoxy resin is present in an amount from about 70% to about 95% by weight based on a total weight of the mixture.

Aspect 8. The metal-organic thermoset polymer of any one of aspects 1-7, wherein the epoxy resin and metal alkoxide are at least partially crosslinked.

Aspect 9. The metal-organic thermoset polymer of any one of aspects 1-8, wherein the polymer is formed in the absence of a hardener.

Aspect 10. The metal-organic thermoset polymer of any one of aspects 1-8, wherein the mixture further comprises a hardener, an inhibitor, or a catalyst.

Aspect 11. An article comprising a metal-organic thermoset polymer of any one of aspects 1-10.

Aspect 12. The article of aspect 11 selected from a structural material, an insulation material, an adhesive, a coating, a sealant, an optical material, an electronic material, a radiation shielding material, a biomaterial, an automotive material, or a textile.

Aspect 13. A process for preparing a metal-organic thermoset polymer, the process comprising:
a) mixing at least one epoxy resin and at least one metal alkoxide to form a mixture; and
b) heating the mixture to a temperature above the melting point of the metal alkoxide to form the metal-organic thermoset polymer.

Aspect 14. The process of aspect 13, wherein heating the mixture occurs in a pressurized mold.

Aspect 15. The process of aspect 13 or aspect 14, wherein the process is performed under an inert atmosphere.

Aspect 16. The process of any one of aspects 13-15, wherein the at least one metal alkoxide comprises aluminum isopropoxide.

Aspect 17. The process of any one of aspects 13-16, wherein the at least one metal alkoxide is present in an amount from about 5% to about 30% by weight based on a total weight of the mixture.

Aspect 18. The process of any one of aspects 13-17, wherein the at least one epoxy resin comprises an aliphatic epoxy resin, a bisphenol epoxy resin, a novolac epoxy resin, a glycidylamine epoxy resin, a halogenated epoxy resin, or combinations thereof.

Aspect 19. The process of any one of aspects 13-18, wherein the at least one epoxy resin is present in an amount from about 70% to about 95% by weight based on a total weight of the mixture.

20. A metal-organic thermoset polymer formed by the process of any one of claims 13-19.

A number of aspects of the disclosure have been described. Nevertheless, it will be understood that various modifications may be made without departing from the spirit and scope of the invention. Accordingly, other aspects are within the scope of the following claims.

By way of non-limiting illustration, examples of certain aspects of the present disclosure are given below.

### EXAMPLES

The following examples are set forth below to illustrate the compositions, articles, and methods claimed herein, along with associated methods and results according to the disclosed subject matter. These examples are not intended to be inclusive of all aspects of the subject matter disclosed herein, but rather to illustrate representative methods and results. These examples are not intended to exclude equivalents and variations of the present disclosure, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1. An Epoxy-Aluminum Isopropoxide Organic-Inorganic Hybrid Material

Conventional composites incorporating functionalized fillers have made substantial progress in achieving interfacial compatibility and synergistic performance, particularly in thermosetting systems. Advances in surface chemistry, particle functionalization, and interface engineering have enabled improved stress transfer, dispersion, and even reactive coupling between phases. As a result, many composite materials today exhibit excellent mechanical and thermal properties derived from cooperative interactions between organic matrices and inorganic fillers (48-50).

However, a growing body of research has focused on materials that go beyond phase blending or interfacial adhesion, targeting molecular-level integration of organic and inorganic domains. These systems, often referred to as organic-inorganic hybrids, are characterized by their interpenetrating network structures, covalent linkages, or in-situ formation mechanisms that incorporate the inorganic component during matrix synthesis (51-53). Examples include sol-gel-derived hybrids (51), metal-organic frameworks (MOFs) (54,55), and other co-networked systems (56,57), where the inorganic phase is not merely dispersed but formed within the organic network. This degree of structural intimacy opens new possibilities for designing materials with enhanced cohesion, thermal resistance, and functional tunability at the nanometer scale. In conventional nanocomposites, inorganic fillers are dispersed within the organic matrix with clustered agglomerates and nonuniform interfacial compatibility. In contrast, organic-inorganic hybrids feature a more continuous and better distribution of compatibilized phases, often linked through covalent or coordination, resulting in improved compatibility, stress transfer, and property synergy.

The successful design of organic-inorganic hybrid thermosets relies critically on strong and stable interactions between organic polymer matrices and inorganic fillers. From a molecular perspective, synergy arises when these building blocks are effectively integrated, enabling the material to respond cooperatively to mechanical, thermal, or chemical stimuli.

Several approaches have been developed to facilitate molecular-level coupling between organic and inorganic domains. One commonly employed method involves surface functionalization using coupling agents, typically silanes, which introduce reactive organic moieties onto inorganic surfaces. This allows the formation of stable covalent bonds between fillers and polymer chains, significantly enhancing interfacial adhesion and load transfer capabilities. For example, either thorough surface-initiated ‘grafting-from’ polymerization or ‘grafting-to’ coupling reactions can be employed. These approaches enable precise control over interfacial properties by attaching polymer chains directly onto inorganic particle surfaces (58). Additionally, self-assembly enables the formation of ordered structures at the nanoscale through spontaneous organization of molecular building blocks non-covalently (59,60). These methods help minimize phase separation, leading to improved dispersion and better-controlled morphologies.

Another established route is the sol-gel process, wherein inorganic precursors such as metal alkoxides (e.g., tetraethyl orthosilicate, TEOS) undergo in-situ hydrolysis and condensation reactions within an organic polymer matrix, forming a continuous inorganic network intimately interpenetrated with the organic phase (61,62).

A more recent approach involves the use of MOFs (54,55). MOFs represent a new class of hybrid materials composed of metal ions or clusters coordinated with organic linkers, resulting in highly ordered porous structures at a molecular scale. These materials exhibit exceptional structural uniformity, controlled porosity, and chemical versatility, enabling them to impart unique functional properties not attainable through conventional composite strategies.

Metal alkoxides such as aluminum isopropoxide and titanium isopropoxide are widely used for their polycondensation reaction under hydrolytic conditions through sol-gel processes, forming amorphous inorganic clusters (63-65). However, due to their irregular amorphous structure, they often exhibit inefficient integration with reinforcing fillers when compared to more crystalline alumina particles (66). Instead of forming inorganic gel networks which will be less compatible with matrix, a more direct and efficient strategy would be to utilize the metal alkoxides themselves to form hybrid networks, offering a novel approach to the development of organic-inorganic hybrid materials.

Motivated by these considerations, the direct reaction of inorganic metal alkoxides with epoxy resins represents a promising yet underexplored approach. In particular, aluminum isopropoxide showed interaction with epoxy functionalities by participating as Lewis acids catalyst to initiate epoxy ring opening and network formation, or through direct coordination linkages. This process can result in molecular-scale interpenetration between the organic and inorganic phases, enhancing network integrity, minimizing phase separation, and improving mechanical robustness.

### Materials and Methods

### Material Formulation

A commercial epoxy resin (1159A) was obtained from Composite Envisions. Aluminum isopropoxide (≥98%, Sigma-Aldrich) was used as the catalytic additive. The aluminum isopropoxide, initially in white granular form, was finely ground using a mortar and pestle to enhance dispersibility within the epoxy matrix. The epoxy resin and ground aluminum isopropoxide were blended using a dual-axis centrifugal mixer (FlackTek DAC 400.2 VAC-L). The mixing protocol consisted of an initial 30 s at 900 rpm, followed by a 20 s pause, and a final 2 min at 1500 rpm. After mixing, the formulation was used within a 4-hour working window to minimize deactivation of the moisture-sensitive aluminum isopropoxide.

### Curing Kinetics

### Differential Scanning Calorimetry (DSC) Analysis

Thermal curing behavior was investigated using a Mettler Toledo DSC 3+ instrument equipped with an autosampler. All measurements were conducted using 40 μl aluminum pans with pin-holed lids, containing 7-10 mg of sample.

### Non-Isothermal Scans:

To determine suitable isothermal curing temperatures, a non-isothermal scan was first conducted from room temperature to 290° C. at a heating rate of 5° C./min. The peak of exothermic reaction was observed near 170° C., guiding the selection of target isothermal temperatures.

### Isothermal Scans:

Isothermal DSC experiments were conducted at 120, 140, 160, and 180° C. Each sample was equilibrated at room temperature for 2 min, then rapidly heated to the target temperature at 75° C./min. The exothermic heat flow was monitored over time to capture isothermal curing kinetics.

### Total Enthalpy Calculation:

To estimate the total reaction enthalpy, a two-step combined DSC procedure was applied. After completing the isothermal cure, the partially cured sample was cooled down to room temperature and then a second non-isothermal heating scan from room temperature to 310° C. at 20° C./min was performed to capture the residual exothermic signal. The total curing enthalpy was determined by summing the heat evolved during both isothermal and post-isothermal scans.

### High-Pressure Curing Setup:

Approximately 4 g of the epoxy-aluminum isopropoxide mixture was prepared following the same mixing protocol described above. The mixture was cast into a silicone mold and placed into a custom-designed high-pressure reaction vessel. The vessel was sealed and connected to a nitrogen gas supply, pressurizing the chamber to 300 psi via a direct line fitted through the wall of a convection oven. The pressurized system was heated to 170° C., and the cure was maintained for 1 hour upon reaching the target temperature.

### Results and Discussion

### Design of High-Pressure Mold to Cure Epoxy-ALP Resin

To produce ALP-cured epoxy samples in a high-pressure environment, we designed a high-pressure vessel using stainless steel piping and end caps rated for high-pressure uses. The reactor will be externally pressurized using N₂ gas and be placed inside an oven where samples can be cured at a temperature of 170° C. for 2 hours, the identified conditions for curing the epoxy-ALP mixture. By using silicone or metal molds within the reactor, epoxy resin samples of different shapes and sizes can be produced and used to test various mechanical and thermal properties, as well as the crosslinking density through multiple methods (e.g., Swelling Ratio, DSC, TGA).

### High-Pressure and Low-Pressure Samples

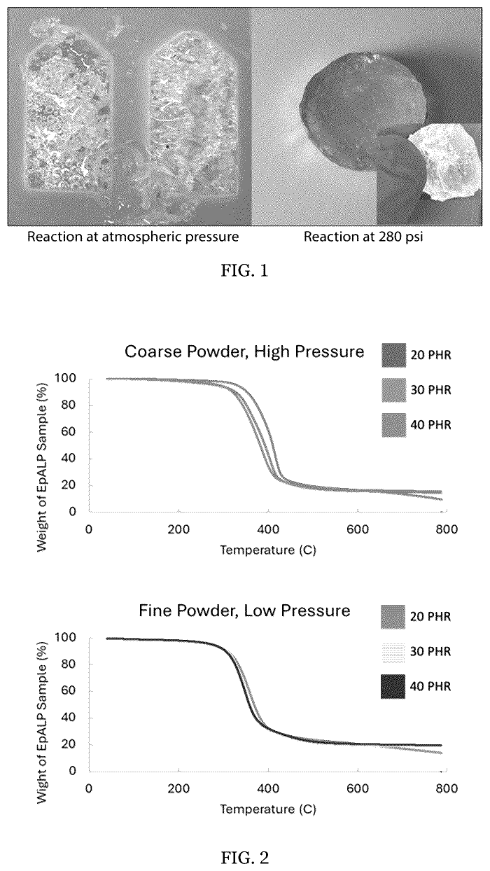

A set of epoxy-ALP resin samples were cured at standard pressure conditions. The samples cured at standard pressure resulted in the bubbling of the resin during the curing process, likely due to the escape of gasses during the curing process. These samples were characterized alongside the samples cured in a high-pressure environment. Photographs of the two samples are shown in FIG. 1. Qualitatively, the samples cured in the high-pressure environment were more rigid and less flexible than those cured at low pressure, and they showed different initial swelling ratios, DSC features, and degradation temperatures. It is important to note that the high-pressure samples were mixed with coarse ALP powder, and the low-pressure samples were mixed with fine powder ALP that was ground using a mortar and pestle. Two variables are being compared when examining the preliminary data for the coarse powder, high pressure (CPHP), and the fine powder, low pressure (FPLP) samples.

The epoxy-ALP samples were created using different concentrations of ALP, measured by the PHR or the parts of the additive ALP per 100 grams of resin. For both CPHP and FPLP samples, 20, 30, and 40 PHR samples were prepared.

### Cross-Linking Density

Cross-linking density was initially assessed through the swelling ratio of the epoxy-ALP samples in different solvents, including ethanol (EtOH), toluene, and water. Although the swelling ratio alone isn't a direct measurement of the cross-linking density of the sample, a sample with a higher degree of crosslinking will exhibit a lower degree of swelling than one with a lower degree of crosslinking. Thus, we can estimate differences in the cross-linking density based on how much the swelling differs between the compositions (increasing concentrations of ALP in this case). The swelling ratio was experimentally determined by separating pieces of the cured epoxy-ALP sample, weighing them, and submerging them in solvent (EtOH, toluene, water) for 48 hours. Samples were then removed from the solvent and weighed. The solvent ratio was calculated as a percentage using the following formula:

$$\frac{{w}_{f} - {w}_{i}}{{w}_{i}} * 100 ,$$

where wᵢ is the initial weight of the sample and w_{f} is the final weight after 48 hours in solvent.

Table 1 shows the swelling ratio (in percentage) for each solvent tested for CPHP and FPLP samples with different compositions. The FPLP samples showed a higher swelling ratio than the CPHP samples. The FPLP samples show a steady increase in swelling ratio as the ALP concentration increases, suggesting lower crosslinking density at higher PHR. Interestingly, this relationship was not observed for the CPHP samples. Instead, the CPHP samples showed the highest swelling ratio for the 30 PHR samples for EtOH and water. Note that the Toluene sample fell apart for the 20 PHR CPHP sample and was not recorded.

TABLE 1
Crosslinking Density Assessment via Swelling Ratio
for CPHP and FPLP samples in EtOH, Toluene, and H₂O

| Sample | EtOH | Toluene | H₂O |
|---|---|---|---|
| CPHP 20 | 7.8% | N/A | 8.9% |
| CPHP 30 | 10.4% | 82.7% | 10% |
| CPHP 40 | 8.8% | 72.8% | 8.3% |
| FPLP 20 | 182.4% | 226.8% | 119.4% |
| FPLP 30 | 234.1% | 300.1% | 132.8% |
| FPLP 40 | 268.3% | 410.4% | 234.1% |

The glass transition temperature (T_{g}) of the CPHP and FPLP samples is also expected to change with the degree of crosslinking and was obtained through differential scanning calorimetry (DSC). A dynamic DSC heating cycle was used to bring the samples up to 180° C. twice, measuring the primary and secondary heating. The T_{g} was recorded during the first heating of the samples. The T_{g} for each sample is recorded in Table 2. Interestingly, the lowest T_{g} was observed for the 30 PHR samples of both CPHP and FPLP groups, with the CPHP 30 PHR sample being the weakest. The T_{g} for the FPLP samples showed the least change between different ALP concentrations, the lowest being 30 PHR (T_{g}=20 C) and the highest being 20 PHR (T_{g}=24.11 C). The CPHP samples showed a more extensive temperature range between samples. Similar to the FPLP group, the lowest CPHP sample was 30 PHR ((T_{g}=9.96° C.), and the highest was 20 PHR (T_{g}=41.14° C.). Further DSC analysis is needed to conclude the trends in cross-linking density of the samples, including dynamic DSC up to 230° C. The initial data points show interesting differences between samples prepared at high-pressure and low-pressure.

TABLE 2
Glass transition temperature obtained
for CPHP and FPLP samples via DSC

| Sample | T_{g} (C.) |
|---|---|
| CPHP 20 | 41.14 |
| CPHP 30 | 9.96 |
| CPHP 40 | 13.44 |
| FPLP 20 | 24.11 |
| FPLP 30 | 20 |
| FPLP 40 | 22.27 |

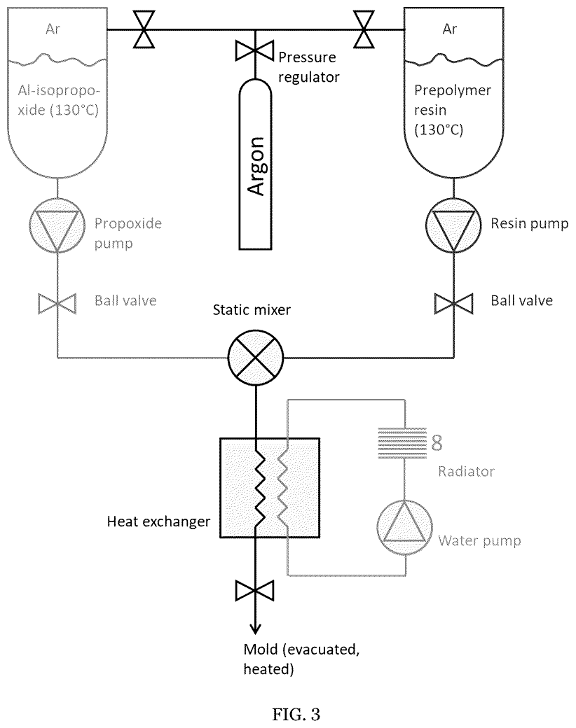

The thermal degradation of the epoxy-ALP system was studied using thermogravimetric analysis (TGA). The samples were heated up to 800° C., and the temperature of 5% weight loss (T_{95%}) and the residual weight at max temperature (RW %) were recorded and are shown in FIG. 2 and Table 3. The T_{95%} informs when the epoxy-ALP sample begins to degrade, and the RW % can indicate the overall thermal stability. The thermal degradation results reported only include 1 data point for each epoxy-ALP sample and should not be used to draw any definitive conclusions about the materials. They give us initial insights into the nature of the epoxy-ALP systems. The CPHP epoxy-ALP samples showed a decrease in T_{95%} as the concentration of ALP increased. The inverse relationship was observed for RW %, increasing as PHR increases. At 20 PHR: T_{95%}=331.4° C., RW %=9.44% while at 40 PHR T_{95%}=292.1° C., RW %=15.57%. The FPLP samples showed the highest T_{95%} at 30 PHR, while the values for 20 PHR and 40 PHR were very similar (20 PHR: T_{95%}=279.02° C., 30 PHR: T_{95%}=284.6° C., 40 PHR: T_{95%}=273.06° C.). Like the CPHP samples, the RW % increases as the concentration of the FPLP samples increases. (20 PHR: RW %=13.78%, 30 PHR: RW %=18.48%, 40 PHR: RW %=19.47%). When comparing the thermal degradation of the CPHP and FPLP samples, we can see that the difference between the highest and lowest FPLP T_{95%} was much less than the observed difference for the CPHP samples. Interestingly, the T_{95%} for both 30 PHR samples was very similar (284.5 vs 284.6° C. respectively), although the FPLP 20 PHR and 40 PHR samples showed lower T_{95%} than their respective CPHP samples. All the observed FPLP samples showed higher RW % than their respective CPHP samples.

Further TGA data points are needed to be conclusive; in the meantime, these are observations are made from limited data sets.

TABLE 3
Temperature of 5% degradation (T95%) and residual
weight % at max temperature obtained b TGA

| Sample | T_{95%} (C.) | RW % |
|---|---|---|
| CPHP 20 | 331.4 | 9.44% |
| CPHP 30 | 284.5 | 14.45% |
| CPHP 40 | 292.1 | 15.57% |
| FPLP 20 | 279.02 | 13.78 |
| FPLP 30 | 284.6 | 18.48 |
| FPLP 40 | 273.86 | 19.47 |

Preliminary data on the physical properties of the epoxy-ALP organic-inorganic hybrid system has resulted in interesting observations that warrant additional research. The differences and similarities observed between the CPHP and LPHP samples and throughout the crosslinking density (e.g., swelling ratio, DSC) and thermal degradation (e.g., TGA) assessments indicate that the epoxy system is interacting and potentially crosslinking with the aluminum isopropoxide. Specifically, we showed that we could make sample under high pressure, though samples prepared at low pressure contained significant bubbles. We also showed that the degree of crosslinking is higher for the samples prepared a high pressure than those a low pressure, though the link between ALP content and crosslinking was not yet conclusively determined.

### REFERENCES FOR EXAMPLE 1

(1) Mamunya, Ye. P.; Iurzhenko, M. V.; Lebedev, E. V.; Ischenko, S. S.; Boiteux, G.; Seytre, G. Dielectric and Thermal-Mechanical Properties of Hybrid Organic-Inorganic Polymer Systems Based on Isocyanate-Containing Oligomers. J. Non-Cryst. Solids 2007, 353 (47-51), 4288-4292.
(2) Sanchez, C.; Belleville, P.; Popall, M.; Nicole, L. Applications of Advanced Hybrid Organic-Inorganic Nanomaterials: From Laboratory to Market. Chem. Soc. Rev. 2011, 40 (2), 696-753.
(3) Judeinstein, P.; Sanchez, C. Hybrid Organic-Inorganic Materials: A Land of Multidisciplinarity. J Mater Chem 1996, 6 (4), 511-525.
(4) Guerrero, F.; De la Flor, S.; Ramis, X.; Santos, J.-I.; Serra, A. Novel Hybrid Organic/Inorganic Poly(Thiourethane) Covalent Adaptable Networks. Eur. Polym. J. 2022, 174, 111337.
(5) Mammeri, F.; Bourhis, E. L.; Rozes, L.; Sanchez, C. Mechanical Properties of Hybrid Organic-Inorganic Materials. J. Mater. Chem. 2005, 15 (35-36), 3787-3811.
(6) Wei, Y.; Jin, D.; Yang, C.; Kels, M. C.; Qiu, K.-Y. Organic-Inorganic Hybrid Materials: Relations of Thermal and Mechanical Properties with Structures. Mater. Sci. Eng. C 1998, 6 (2-3), 91-98.
(7) Macan, J.; Ivanković, H.; Ivanković, M.; Mencer, H. J. Study of Cure Kinetics of Epoxy-Silica Organic-Inorganic Hybrid Materials. Thermochim. Acta 2004, 414 (2), 219-225.
(8) Liu, Y.; Fan, L.; Xu, X.; Mo, S.; Peng, D.; Mu, Q.; Zhu, C.; Li, C.; Xu, J. Melt Fluidity and Thermal Property of Thermosetting Siloxane-Containing Polyimide Resins and Their Organic/Inorganic Hybrid Characteristics. Mater. Today Commun. 2020, 25, 101443.
(9) Decostanzi, M.; Ecochard, Y.; Caillol, S. Synthesis of Sol-Gel Hybrid Polyhydroxyurethanes. Eur. Polym. J. 2018, 109, 1-7.
(10) Yang, C.; Tang, Y. H.; Lam, W. M.; Lu, W. W.; Gao, P.; Zhao, C. B.; Yuen, M. M. F. Moisture-Cured Elastomeric Transparent UV and X-Ray Shielding Organic-Inorganic Hybrids. J. Mater. Sci. 2010, 45 (13), 3588-3594.
(11) Gomez-Romero, P. Hybrid Organic-Inorganic Materials—In Search of Synergic Activity. Adv. Mater. 2001, 13 (3), 163-174.
(12) Stewart, K. A.; DeLellis, D. P.; Lessard, J. J.; Rynk, J. F.; Sumerlin, B. S. Dynamic Ablative Networks: Shapeable Heat-Shielding Materials. ACS Appl. Mater. Interfaces 2023, 15 (21), 25212-25223.
(13) Shundo, A.; Yamamoto, S.; Tanaka, K. Network Formation and Physical Properties of Epoxy Resins for Future Practical Applications. JACS Au 2022, 2 (7), 1522-1542.
(14) Decostanzi, M.; Ecochard, Y.; Caillol, S. Synthesis of Sol-Gel Hybrid Polyhydroxyurethanes. Eur. Polym. J. 2018, 109, 1-7.
(15) Hendricks, N. R.; Carter, K. R. Nanoimprint Lithography of Polymers. In Polymer Science: A Comprehensive Reference; Elsevier, 2012; pp 251-274.
(16) Macan, J.; Brnardić, I.; Orlić, S.; Ivanković, H.; Ivanković, M. Thermal Degradation of Epoxy-Silica Organic-Inorganic Hybrid Materials. Polym. Degrad. Stab. 2006, 91 (1), 122-127.
(17) Jin, Z.; Graber, L.; Langston, G. J.; Uhrik, T.; Ghosh, S.; Liu, Y.; Stingelin, N.; Kalaitzidou, K.; Levy, U.; Tal, N. Mechanical and Thermal Properties of Epoxy Containing Aluminum Isopropoxide Precursors Compared to Aluminum Oxide. In 2024 IEEE Electrical Insulation Conference (EIC); IEEE: Minneapolis, MN, USA, 2024; pp 99-102.

### FURTHER REFERENCES FOR EXAMPLE 1

(48) Zhang, X.; Li, B.-W.; Dong, L.; Liu, H.; Chen, W.; Shen, Y.; Nan, C.-W. Superior Energy Storage Performances of Polymer Nanocomposites via Modification of Filler/Polymer Interfaces. Advanced Materials Interfaces 2018, 5 (11), 1800096. https://doi.org/10.1002/admi.201800096.
(49) Wang, S.; Luo, Z.; Liang, J.; Hu, J.; Jiang, N.; He, J.; Li, Q. Polymer Nanocomposite Dielectrics: Understanding the Matrix/Particle Interface. ACS Nano 2022, 16 (9), 13612-13656. https://doi.org/10.1021/acsnano.2007404.
(50) Taguet, A.; Cassagnau, P.; Lopez-Cuesta, J.-M. Structuration, Selective Dispersion and Compatibilizing Effect of (Nano) Fillers in Polymer Blends. Progress in Polymer Science 2014, 39 (8), 1526-1563. https://doi.org/10.1016/j.progpolymsci.2014.04.002.
(51) Pandey, S.; Mishra, S. B. Sol-Gel Derived Organic-Inorganic Hybrid Materials: Synthesis, Characterizations and Applications. J Sol-Gel Sci Technol 2011, 59 (1), 73-94. https://doi.org/10.1007/s10971-011-2465-0.
(52) Zhao, N.; Yan, L.; Zhao, X.; Chen, X.; Li, A.; Zheng, D.; Zhou, X.; Dai, X.; Xu, F.-J. Versatile Types of Organic/Inorganic Nanohybrids: From Strategic Design to Biomedical Applications. Chem. Rev. 2019, 119 (3), 1666-1762. https://doi.org/10.1021/acs.chemrev.8b00401.
(53) Rebber, M.; Willa, C.; Koziej, D. Organic-Inorganic Hybrids for CO2 Sensing, Separation and Conversion. Nanoscale Horizons 2020, 5 (3), 431-453. https://doi.org/10.1039/C9NH00380K.
(54) Kalaj, M.; Bentz, K. C.; Ayala, S. Jr.; Palomba, J. M.; Barcus, K. S.; Katayama, Y.; Cohen, S. M. MOF-Polymer Hybrid Materials: From Simple Composites to Tailored Architectures. Chem. Rev. 2020, 120 (16), 8267-8302. https://doi.org/10.1021/acs.chemrev.9b00575.
(55) Tan, J. C.; Cheetham, A. K. Mechanical Properties of Hybrid Inorganic-Organic Framework Materials: Establishing Fundamental Structure-Property Relationships. Chem. Soc. Rev. 2011, 40 (2), 1059-1080. https://doi.org/10.1039/C0CS00163E.
(56) Demeyer, S.; Athipornchai, A.; Pabunrueang, P.; Trakulsujaritchok, T. Development of Mangiferin Loaded Chitosan-Silica Hybrid Scaffolds: Physicochemical and Bioactivity Characterization. Carbohydrate Polymers 2021, 261, 117905. https://doi.org/10.1016/j.carbpol.2021.117905.
(57) John, Ł.; Janeta, M.; Szafert, S. Synthesis of Cubic Spherosilicates for Self-Assembled Organic-Inorganic Biohybrids Based on Functionalized Methacrylates. New Journal of Chemistry 2018, 42 (1), 39-47. https://doi.org/10.1039/C7NJ02533E.
(58) Sun, W.; Shi, J.; Chen, C.; Li, N.; Xu, Z.; Li, J.; Lv, H.; Qian, X.; Zhao, L. A Review on Organic-Inorganic Hybrid Nanocomposite Membranes: A Versatile Tool to Overcome the Barriers of Forward Osmosis. RSC Adv. 2018, 8 (18), 10040-10056. https://doi.org/10.1039/C7RA12835E.
(59) Gou, X.; Cheng, F.; Shi, Y.; Zhang, L.; Peng, S.; Chen, J.; Shen, P. Shape-Controlled Synthesis of Ternary Chalcogenide ZnIn2S4 and CuIn(S,Se)2 Nano-/Microstructures via Facile Solution Route. J. Am. Chem. Soc. 2006, 128 (22), 7222-7229. https://doi.org/10.1021/ja0580845.
(60) Nam, K. T.; Kim, D.-W.; Yoo, P. J.; Chiang, C.-Y.; Meethong, N.; Hammond, P. T.; Chiang, Y.-M.; Belcher, A. M. Virus-Enabled Synthesis and Assembly of Nanowires for Lithium Ion Battery Electrodes. Science 2006, 312 (5775), 885-888. https://doi.org/10.1126/science.1122716.
(61) Schubert, U.; Huesing, N.; Lorenz, A. Hybrid Inorganic-Organic Materials by Sol-Gel Processing of Organofunctional Metal Alkoxides. Chem. Mater. 1995, 7 (11), 2010-2027. https://doi.org/10.1021/cm00059a007.
(62) Kessler, V. G.; Spijksma, G. I.; Seisenbaeva, G. A.; Håkansson, S.; Blank, D. H. A.; Bouwmeester, H. J. M. New Insight in the Role of Modifying Ligands in the Sol-Gel Processing of Metal Alkoxide Precursors: A Possibility to Approach New Classes of Materials. J Sol-Gel Sci Technol 2006, 40 (2), 163-179. https://doi.org/10.1007/s10971-006-9209-6.
(63) Daneshmand-Jahromi, S.; Karami, D.; Mahinpey, N. Novel Synthesis of High-Surface-Area Alumina Using Toluene-Dimethylformamide as Synthetic Media. Journal of Environmental Chemical Engineering 2022, 10 (2), 107204. https://doi.org/10.1016/j.jece.2022.107204.
(64) Khodaparast, P.; Ounaies, Z. Influence of Dispersion States on the Performance of Polymer-Based Nanocomposites. Smart Mater. Struct. 2014, 23 (10), 104004. https://doi.org/10.1088/0964-1726/23/10/104004.
(65) Sanwaria, A. R.; Nagar, M.; Bohra, R.; Chaudhary, A.; Mobin, S. M.; Mathur, P.; Choudhary, B. L. Sol-Gel Synthesis of Highly Pure α-Al2O3 Nano-Rods from a New Class of Precursors of Salicylaldehyde-Modified Aluminum(III) Isopropoxide. Crystal and Molecular Structure of [Al(OC6H4CHO)3]. RSC Adv. 2014, 4 (57), 30081-30089. https://doi.org/10.1039/C4RA03245D.
(66) Rutkowska, I.; Marchewka, J.; Jeleń, P.; Odziomek, M.; Korpyś, M.; Paczkowska, J.; Sitarz, M. Chemical and Structural Characterization of Amorphous and Crystalline Alumina Obtained by Alternative Sol-Gel Preparation Routes. Materials 2021, 14 (7), 1761. https://doi.org/10.3390/ma14071761.

### Example 2. Mechanical and Thermal Properties of Epoxy Containing Aluminum Isopropoxide Precursors Compared to Aluminum Oxide

Epoxy resins are often used as dielectric encapsulants for transformer windings. While their dielectric properties are outstanding, they lack thermal conductivity and suffer under substantial shrinking and large coefficient of thermal expansion. A common solution is to mix micro-sized aluminum oxide particles into the epoxy, which improves the thermal performance. We compare this to an alternative approach: adding aluminum isopropoxide precursors, which could chemically react and bond to the epoxy chains at the molecular level. We compare both solutions experimentally and test the tensile strength, specific heat capacity, and thermal conductivity. A method for mixing the aluminum isopropoxide with epoxy resin has also been proposed.

### Introduction

Solid State Transformers (SSTs) are gaining popularity for their application in various emerging technologies, including the integration of renewable energy sources like wind and solar. The SST is fundamentally defined as a structure consisting of at least two power converters and one medium/high frequency transformer in-between [1]. Medium voltage and medium frequency (MV-MF) transformers are typically used for harvesting solar energy in photovoltaic (PV) farms [2]. The design of MV-MF transformers is very challenging due to the fast voltage transients and the elevating operating temperature resulting from the high power density requirement [3]. Furthermore, PV applications require to pass rigorous basic insulation level requirements due to potential exposure to lightning strikes. Dry-type transformer design is usually adopted for MV-MF transformers. The insulation material for windings is typically based on either epoxy resin [4] or silicone elastomer [3], [5]. Mixing micrometer-sized alumina (Al₂O₃) particles with epoxy resin can enhance the mechanical and thermal conductivity of the composites, as well as improve the dimensional stability of the cured compound [6]. However, alumina particle aggregation can occur in the epoxy resin. In addition, the filled epoxy resin typically has higher losses and lower glass transition temperatures [3]. In this example, a technique was explored to potentially achieve an epoxy compound with the better performance than the epoxy/Al₂O₃ composite. It involves using aluminum isopropoxide as the precursor to achieve molecular bonds with the epoxy molecule, rather than solely relying on surface adhesion when mixing alumina particles with the epoxy resin. The work in [7] used a similar technique, but it is for adding poly(vinyl alcohol) PVAI/titanium oxide hydrate hybrid to the fluorinated polymer. The experimental data showing the thermal and mechanical performance of both the epoxy samples, i.e., with alumina and with the precursor of the aluminum isopropoxide, were compared.

### Processing Options

While alumina powder can be dry mixed [8] into the prepolymer resin by using a lab-grade stirrer, the same process does not work well with the aluminum isopropoxide, potentially due to increased molecular volume of trimer and tetramer of aluminum isopropoxide [9] and elevated bonding energy between aluminum isopropoxide and the prepolymer. Such processing leads to clumping and uneven distribution of particles. A common method of mixing aluminum isopropoxide into the resin consists of dissolving the Al-isopropoxide with subsequent mixing the solution into the resin. This method is known as solution processing and has been proven to work well for thin films where the solvent can be evaporated easily after mixing [10]. This method is however less suitable for molded parts due to the challenges associated with evaporating large amounts of solvents.

The method used here was melt processing [9]. Aluminum isopropoxide has a melting point of approximately 130° C. [11]. As a liquid, it can be mixed into the resin, which should also be preheated to the same temperature to avoid re-crystallization. The challenge is that liquid isopropoxide starts reacting with the resin upon contact. The reaction is exothermal, which can easily lead to thermal runaway. It is therefore essential to cool the liquid mixture in an ice bath. Once it has reached room temperature, the hardener can be stirred in safely.

### Sample Preparation

### Alumina Samples

The epoxy resin used in this example is from Composite Envisions. Their so-called “2:1 epoxy hardener,” which is their slowest curing option, was used to the maximize the working time. The process of preparing the alumina samples is listed as the following.
1) Weigh powdered alumina (30.6 g);
2) Weigh epoxy (183.5 g);
3) Weigh hardener (91.75 g);
4) Combine epoxy and powdered alumina at RT. Stir for 5 minutes;
5) Add hardener. Stir for 5 minutes;
6) Degas mixture in vacuum while still in beaker for 7 minutes;
7) Add to open molds and degas in vacuum for 7 minutes.
   Samples with Aluminum Isopropoxide

The process of preparing the samples with aluminum triisopropoxide precursor is listed below. It features the melting of aluminum isopropoxide first.
1) Weigh aluminum tri-isopropoxide (30.6 g);
2) Weigh epoxy (183.5 g);
3) Weigh hardener (61.17 g);
4) Place beaker with epoxy and separate beaker with isopropoxide in oven (preheated to 150° C.);
5) Once both beakers reach 130° C., transfer the resin beaker onto a hot plate (preheated to 130° C.);
6) Quickly pour the isopropoxide into the resin beaker while stirring for 10-20 seconds then transfer beaker to ice bath and keep stirring until cooled to RT;
7) Pour hardener (RT) into the epoxy-precursor mixture while stirring;
8) Degas the mixture for 7 minutes.

### Characterization

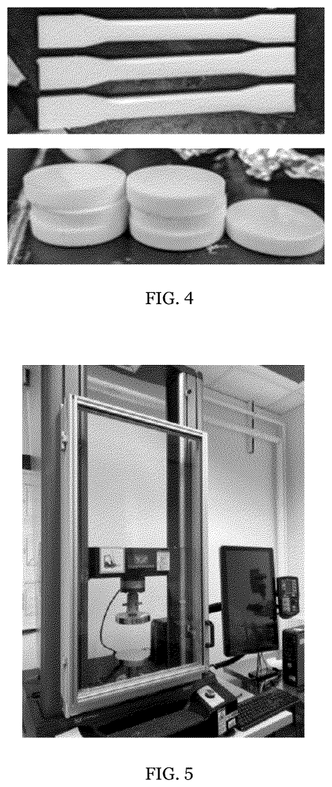

Different geometries of samples were designed and fabricated. As shown in FIG. 4, the “dogbone” samples were prepared for the tensile strength tests and the disk samples were for the thermal conductivity tests. Both types of samples, with alumina and with the precursor of aluminum isopropoxide, were cured in open molds.

### Mechanical Properties

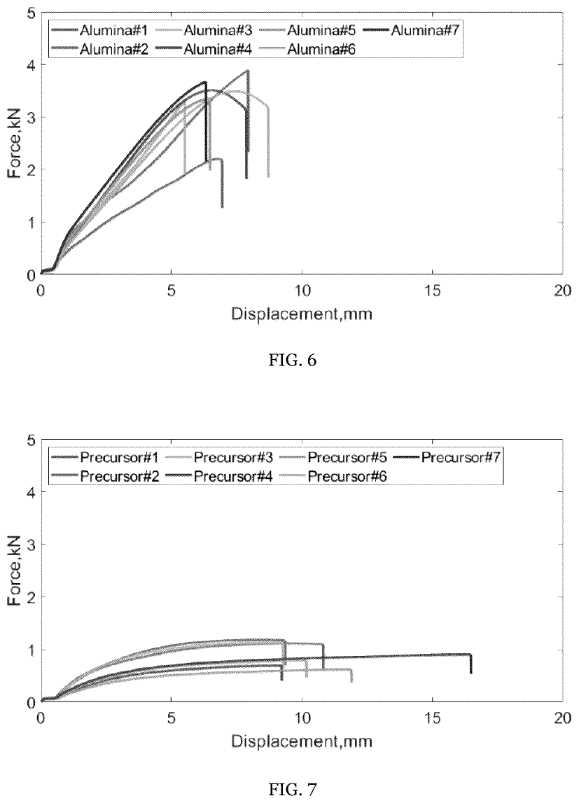

The tensile strength tests were conducted according to the standard ASTM D638. The reduced section in the middle of the “dogbone” sample ensures that the break occurs in the center rather than at the clamping areas, which are at the ends of the sample. The reduced section is 85.85 mm long, 12.7 mm wide and 6.35 mm thick. The tests were conducted with Instron 5967 (as shown in FIG. 5) with a constant speed of 10 mm/min. FIG. 6 and FIG. 7 shows the tensile test results of two types of samples.

Each group of tests includes seven pieces of sample. The alumina sample has a higher tensile strength than the samples with precursors, while the latter is more ductile.

### Thermal Properties

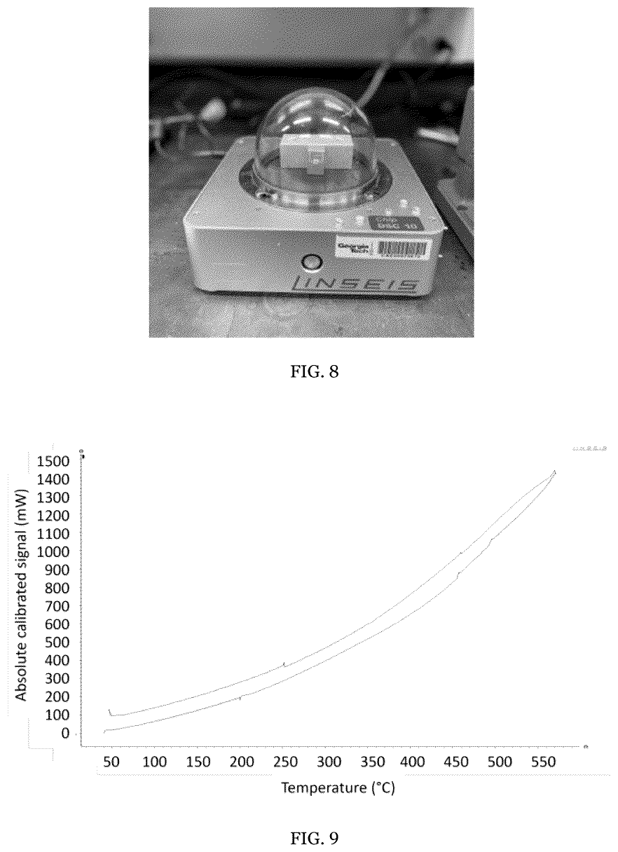

Two groups of thermal experiments were conducted—a measurement of the specific heat capacity by using the differential scanning calorimeter (DSC), and a measurement of the thermal conductivity. Both types of samples were ground to powder for the heat capacity tests in the device Linseris Chip-DSC 10 (as shown in FIG. 8). The disk samples, 38.1 mm in diameter and 6.35 mm in thickness, were molded for the thermal conductivity tests.

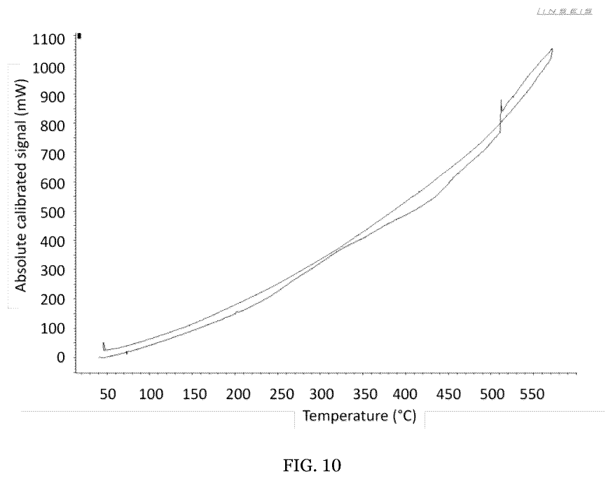

Specific Heat Capacity: During the DSC test, the sample was heated up first to about 575° C. and then cooled down. FIG. 9 and FIG. 10 shows the temperature profile with input heat flow rate for the alumina sample and the sample with precursor, respectively. The sample with precursor has a lower heat capacity than that of the alumina sample. Only one piece of sample was measured for each type.

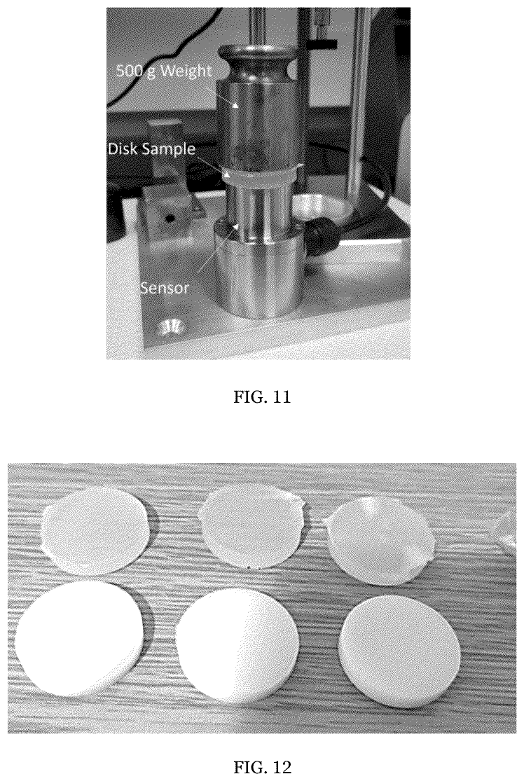

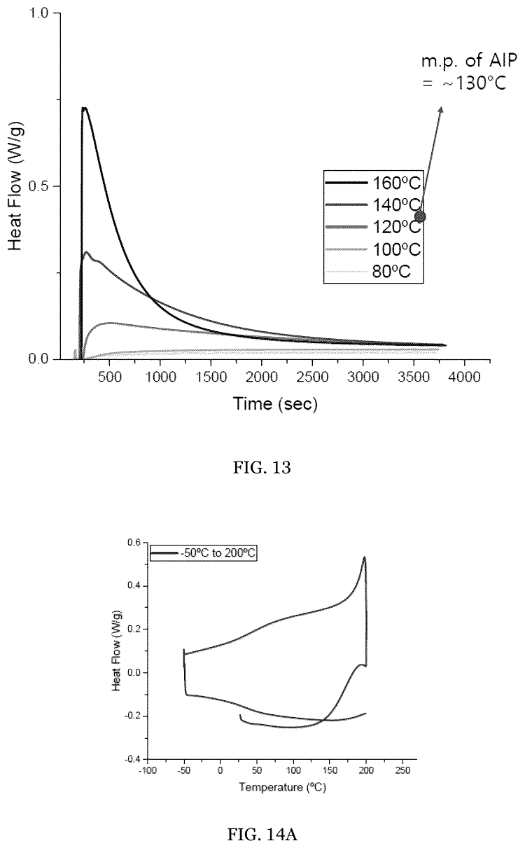

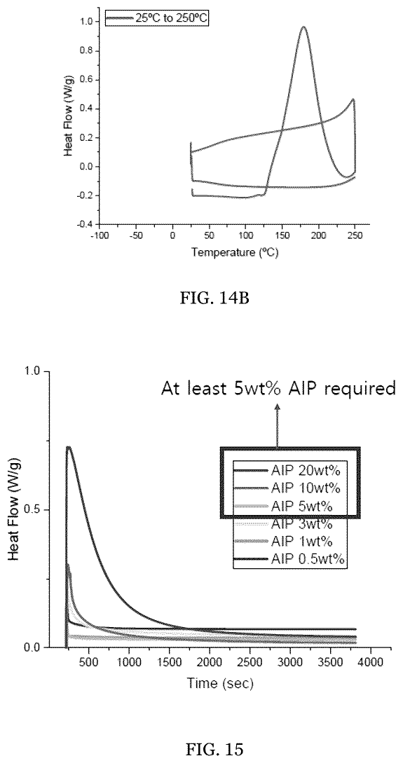

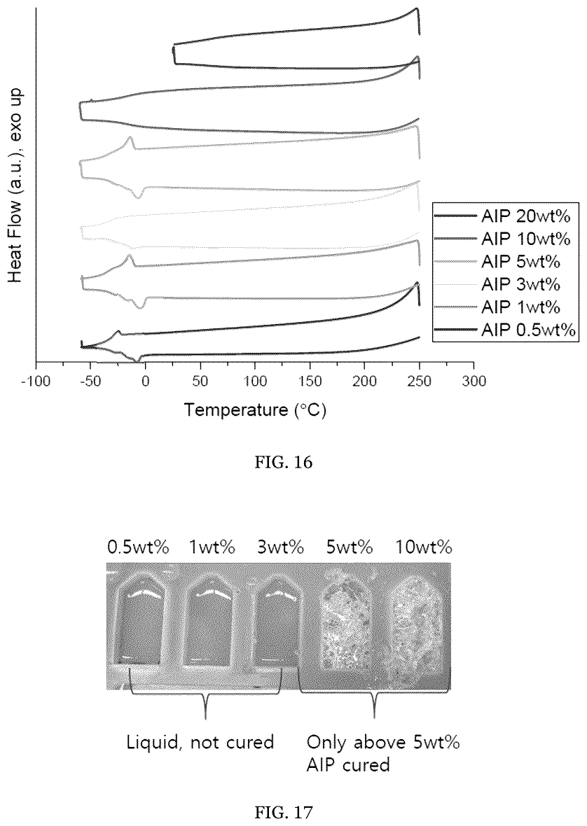

Thermal Conductivity: Three disk samples for each type have been tested on the C-Therm's Trident system. The mode of modified transient plane source (MTPS) was applied for the measurement of thermal conductivity. The measurement procedure conforms to the standard ASTM D7984. FIG. 11 shows the setup for measuring the thermal conductivity. A 500 g weight is placed at the top of the disk sample for ensuring good contact between the sample and the sensor surface. In addition, three drops of water was placed between the sample surface and the sensor surface to compensate slight sample-surface irregularities. Three measurements were conducted for each piece of sample. Table I and Table II show the measurement results for thermal conductivity of the two types of sample. There is no improvement in the thermal conductivity of samples with the precursor of aluminum isopropoxide.

TABLE I
THERMAL CONDUCTIVITY MEASUREMENT RESULTS
OF ALUMINA SAMPLES (UNIT: W/(m · K))

| | Measurement | Measurement | Measurement | |
|---|---|---|---|---|
| Sample# | #1 | #2 | #3 | Mean |
| 1 | 0.364 | 0.357 | 0.357 | 0.359 |
| 2 | 0.386 | 0.388 | 0.380 | 0.385 |
| 3 | 0.260 | 0.259 | 0.259 | 0.259 |

TABLE II
THERMAL CONDUCTIVITY MEASUREMENT RESULTS OF
SAMPLES WITH PRECURSOR (UNIT: W/(m · K))

| | Measurement | Measurement | Measurement | |
|---|---|---|---|---|
| Sample# | #1 | #2 | #3 | Mean |
| 1 | 0.264 | 0.278 | 0.289 | 0.277 |
| 2 | 0.271 | 0.269 | 0.267 | 0.269 |
| 3 | 0.279 | 0.271 | 0.275 | 0.275 |

### Discussion

When compared with the mechanical and thermal performance of alumina samples, the samples with aluminum isopropoxide show no improvements. Specifically, the tensile strength of the aluminum isopropoxide sample is less than 50% of that of the alumina sample, and its thermal conductivity is about 80%. However, this example only includes one recipe, which is the first one being tried. In addition, innovative melt processing was proposed for mixing the aluminum isopropoxide with the epoxy resin, and the aluminum isopropoxide samples were successfully made as shown in FIG. 12. There are many potential avenues to improve the recipe, including adjusting the ratios between the epoxy resin and aluminum isopropoxide, selecting different formulations of epoxy resin, and incorporating additives such as the citric acid as an inhibitor to achieve desired chemical reaction rates.

### Conclusion

This example compares the mechanical and thermal properties of cured epoxy resin samples mixed with micro-sized aluminum oxide particles to those mixed with precursors of aluminum isopropoxide. The current formulation as presented here shows promising potential but was ultimately not able to improve upon the already good control group based on epoxy with aluminum oxide.

### REFERENCES FOR EXAMPLE 2

[1] A. E. Shafei, S. Ozdemir, N. Altin, and A. Nasiri. “Development of a High Power, Medium Frequency Transformer for Medium Voltage Applications.” In 2023 IEEE Energy Conversion Congress and Exposition (ECCE), pp. 891-898. IEEE, 2023.
[2] H. Bahaa, P. Enjeti, and S. Ahmed. “A robust controller for medium voltage AC collection grid for large scale Photovoltaic plants based on medium frequency transformers.” In 2016 IEEE Applied Power Electronics Conference and Exposition (APEC), pp. 936-942. IEEE, 2016.
[3] G. Thomas, R. Faerber, D. Rothmund, F. Krismer, C. M. Franck, and J. W. Kolar. “Dielectric losses in dry-type insulation of medium-voltage power electronic converters.” IEEE Journal of Emerging and Selected Topics in Power Electronics, vol. 8, no. 3, pp: 2716-2732, 2020.
[4] L. Rui, C. Li, J. Yu, C. Li, W. Li, and X. He. “Modeling and Design of Insulation Structure for High Power Density Medium Voltage High-Frequency Transformers.” IEEE Journal of Emerging and Selected Topics in Power Electronics 2023.
[5] R. Daniel, T. Guillod, D. Bortis, and J. W. Kolar. “99% efficient 10 kV SiC-based 7 kV/400 V DC transformer for future data centers.” IEEE Journal of Emerging and Selected Topics in Power Electronics, vol. 7, no. 2 pp: 753-767, 2018.
[6] L. Jin, Y. Wang, Y. Wang, Q. Tang, P. Song, H. Liang, and B. Du. “Particle Aggregation State Affecting Insulation Breakdown Characteristics of Epoxy/Al2O3 Composite under Temperature Gradient.” IEEE Transactions on Dielectrics and Electrical Insulation, 2023.
[7] B. Stefan, H. Yuan, A. Strang, A. Levitsky, G. L. Frey, A. Hafner, D. DC Bradley, P. N. Stavrinou, and N. Stingelin. “Fully Solution-Processed Photonic Structures from Inorganic/Organic Molecular Hybrid Materials and Commodity Polymers.” Advanced Functional Materials, vol. 29, no. 21, pp: 1808152, 2019.
[8] M. Takahashi, S. Suzuki, H. Nitanada, and E. Arai, “Mixing and Flow Characteristics in the Alumina/Thermoplastic Resin System,” Journal of the American Ceramic Society, vol. 71, no. 12, pp. 1093-199, December 1988.
[9] A. Kowalski, A. Duda, and S. Penczek, “Polymerization of L,L-Lactide Initiated by Aluminum Isopropoxide Trimer or Tetramer,” Macromolecules, vol. 31, no. 7, pp. 2114-2122, April 1998.
[10] S. Blittersdorf, N. Bahlawane, K. Kohse-Höinghaus, B. Atakan, and J. Müller, “CVD of Al2O3 Thin Films Using Aluminum Triisopropoxide,” Chemical Vapor Deposition, vol. 9, no. 4, pp. 194-198, August 2003.
[11] N. Ya. Turova, V. A. Kozunov, A. I. Yanovskii, N. G. Bokii, Yu. T. Struchkov, and B. L. Tarnopol'skii, “Physico-chemical and structural investigation of aluminium isopropoxide,” Journal of Inorganic and Nuclear Chemistry, vol. 41, no. 1, pp. 5-11, January 1979.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A metal-organic thermoset polymer formed from a mixture comprising:
At least one epoxy resin; and
At least one metal alkoxide.

2. The metal-organic thermoset polymer of claim 1, wherein the at least one metal alkoxide comprises an aluminum alkoxide, a titanium alkoxide, an indium alkoxide, or combinations thereof.

3. The metal-organic thermoset polymer of claim 1, wherein the at least one metal alkoxide comprises a metal isopropoxide, a metal tert-butoxide, a metal sec-butoxide, a metal pentoxide, or combinations thereof.

4. The metal organic thermoset polymer of claim 1, wherein the at least one metal alkoxide comprises aluminum isopropoxide.

5. The metal-organic thermoset polymer of claim 1, wherein the at least one metal alkoxide is present in an amount from about 5% to about 30% by weight based on a total weight of the mixture.

6. The metal-organic thermoset polymer of claim 1, wherein the at least one epoxy resin comprises an aliphatic epoxy resin, a bisphenol epoxy resin, a novolac epoxy resin, a glycidylamine epoxy resin, a halogenated epoxy resin, or combinations thereof.

7. The metal-organic thermoset polymer of claim 1, wherein the at least one epoxy resin is present in an amount from about 70% to about 95% by weight based on a total weight of the mixture.

8. The metal-organic thermoset polymer of claim 1, wherein the epoxy resin and metal alkoxide are at least partially crosslinked.

9. The metal-organic thermoset polymer of claim 1, wherein the polymer is formed in the absence of a hardener.

10. The metal-organic thermoset polymer of claim 1, wherein the mixture further comprises a hardener, an inhibitor, or a catalyst.

11. An article comprising a metal-organic thermoset polymer of claim 1.

12. The article of claim 11 selected from a structural material, an insulation material, an adhesive, a coating, a sealant, an optical material, an electronic material, a radiation shielding material, a biomaterial, an automotive material, or a textile.

13. A process for preparing a metal-organic thermoset polymer, the process comprising:
a) mixing at least one epoxy resin and at least one metal alkoxide to form a mixture; and
b) heating the mixture to a temperature above the melting point of the metal alkoxide to form the metal-organic thermoset polymer.

14. The process of claim 13, wherein heating the mixture occurs in a pressurized mold.

15. The process of claim 13, wherein the process is performed under an inert atmosphere.

16. The process of claim 13, wherein the at least one metal alkoxide comprises aluminum isopropoxide.

17. The process of claim 13, wherein the at least one metal alkoxide is present in an amount from about 5% to about 30% by weight based on a total weight of the mixture.

18. The process of claim 13, wherein the at least one epoxy resin comprises an aliphatic epoxy resin, a bisphenol epoxy resin, a novolac epoxy resin, a glycidylamine epoxy resin, a halogenated epoxy resin, or combinations thereof.

19. The process of claim 13, wherein the at least one epoxy resin is present in an amount from about 70% to about 95% by weight based on a total weight of the mixture.

20. A metal-organic thermoset polymer formed by the process of claim 13.
